(19) United States
(12) Patent Application Publication
(10) Pub. No.: US 2026/0241727 A1
(43) Pub. Date: Aug. 20, 2026

(54) PRINTING DEVICE AND PRINTING METHOD

(71) Applicant: MIMAKI ENGINEERING CO., LTD., Nagano (JP)

(72) Inventors: Shunsuke Akuta, Nagano (JP); Youichi Ichikawa, Nagano (JP); Kosuke Murai, Nagano (JP); Sho Koshiba, Nagano (JP)

(73) Assignee: MIMAKI ENGINEERING CO., LTD., Nagano (JP)

(21) Appl. No.: 19/164,218

(22) PCT Filed: Mar. 25, 2024
(86) PCT No.: PCT/JP2024/011536

§ 371 Date: Sep. 11, 2025

(30) Foreign Application Priority Data
Apr. 3, 2023 (JP) 2023-060146
Aug. 23, 2023 (JP) 2023-135852

(51) Int. Cl. B41J 25/00; B41J 2/17; B41J 11/00; B41J 11/06; B41J 29/393

(52) U.S. Cl. CPC B41J 25/005; B41J 2/1707; B41J 2/1721; B41J 11/008; B41J 11/06; B41J 29/393; B41J 2029/3935

(57) ABSTRACT

A printing device 10 includes an inkjet head 102, a main scanning drive portion 18, a sub-scanning drive portion 20, and a control portion 30. In at least some of the main scanning operations, the main scanning drive portion 18 causes the inkjet head 102 to discharge ink to a region other than the image region on the media 50, and as the main scanning operations that cause the inkjet head 102 to discharge ink to a region other than the image region, at least: a first main scanning operation that causes the inkjet head 102 to draw a nozzle state confirmation pattern on a region other than the image region and a second main scanning operation that causes an amount of ink discharged to a region other than the image region different from the first main scanning operation are caused to be performed by the inkjet head 102.

### CROSS-REFERENCE TO RELATED APPLICATION

This application is a 371 application of the International PCT application serial no. PCT/JP2024/011536, filed on Mar. 25, 2024, which claims the priority benefits of Japan Patent Application No. 2023-060146, filed on Apr. 3, 2023 and Japan Patent Application No. 2023-135852, filed on Aug. 23, 2023. The entirety of each of the above-mentioned patent applications is hereby incorporated by reference herein and made a part of this specification.

### TECHNICAL FIELD

The present invention relates to a printing device and a printing method.

### RELATED ART

Conventionally, inkjet printers, which are printing devices that perform printing by an inkjet method, have been widely used. In inkjet printers, in order to ensure stability when discharging ink from nozzles of an inkjet head, flushing may be performed to discharge ink from the nozzles separately from the operation of printing images. Further, regarding flushing, a method of forming a flushing region in a region that is not an image region on paper has been conventionally known (for example, see Patent Document 1).

### CITATION LIST

### Patent Document

Patent Document 1: Japanese Patent Application Laid-Open Publication No. 2003-127429.

### SUMMARY OF INVENTION

### Technical Problem

For inkjet printers, a configuration that enables more appropriate printing on media which is a print target is desired. Even when inkjet printers periodically perform maintenance such as flushing, clogging may occur in nozzles. Thus, in the case of performing printing with an inkjet printer, it is desirable to appropriately confirm the state of the nozzles. Then, the state of the nozzles is desired to be confirmed efficiently and appropriately. Thus, the present invention aims to provide a printing device and printing method that may solve the above problems.

### Solution to Problem

The inventor of the present application conducted intensive research on a method for efficiently and appropriately confirming the state of nozzles in a printing device that performs printing by the inkjet method. In this research, the inventor of the present application considered causing an inkjet head to discharge ink to a region other than an image region, which is a region for drawing images on media to be printed and causing the inkjet head to draw a nozzle state confirmation pattern, which is a pattern for confirming the state of nozzles. With this configuration, the state of nozzles in the inkjet head may be confirmed while causing the inkjet head to perform an operation of drawing images in the image region. This also enables efficient and appropriate confirmation of the state of nozzles. Furthermore, by causing the inkjet head to discharge ink to regions other than the image region, it becomes possible to periodically cause nozzles that do not discharge ink during drawing of images in the image region to discharge ink. This also makes it possible to reduce the occurrence of drying of nozzles. Here, drying of nozzles may be considered as, for example, ink drying in the vicinity of nozzles and affecting the discharge characteristics of the nozzles.

Further, discharge of ink to regions other than the image region may be performed for purposes other than drawing nozzle state confirmation patterns. For example, in the case of using a printing device that causes an inkjet head to perform main scanning operations, it is conceivable to cause the inkjet head to draw nozzle state confirmation patterns in some of the main scanning operations. It is conceivable to make the discharge amount of ink to regions other than the image region different between these some main scanning operations and other main scanning operations. With this configuration, during drawing of images in the image region, the inkjet head may be further caused to discharge ink to regions other than the image region for purposes other than confirmation of the state of nozzles. This also enables more efficient and appropriate confirmation of the state of nozzles.

Furthermore, the inventor of the present application found features necessary to obtain such effects through further intensive research, leading to the present invention. To solve the above problems, the present invention is a printing device that performs printing on media by an inkjet method, the printing device including: an inkjet head, having multiple nozzles that discharge ink; a main scanning drive portion, causing the inkjet head to perform a main scanning operation of discharging ink while moving relatively to the media in a preset main scanning direction; a sub-scanning drive portion, causing the inkjet head to perform a sub-scanning operation of moving relatively to the media in a sub-scanning direction orthogonal to the main scanning direction; and a control portion, controlling operations of the inkjet head, the main scanning drive portion, and the sub-scanning drive portion. The main scanning drive portion causes the inkjet head to perform the main scanning operation multiple times, the sub-scanning drive portion causes the inkjet head to perform the sub-scanning operation between the main scanning operations, in response to a region for drawing an image that becomes a product of printing being defined as an image region, the control portion sets the image region in a partial range of the media in the main scanning direction, in at least some of the main scanning operations, the main scanning drive portion causes the inkjet head to discharge ink to a region other than the image region on the media, and as the main scanning operations that cause the inkjet head to discharge ink to a region other than the image region, at least: a first main scanning operation that is the main scanning operation causing the inkjet head to draw a nozzle state confirmation pattern, which is a pattern for confirming a state of at least some of the nozzles in the inkjet head, on a region other than the image region; and a second main scanning operation that is the main scanning operation making an amount of ink discharged to a region other than the image region different from the first main scanning operation are caused to be performed by the inkjet head.

By causing the inkjet head to draw the nozzle state confirmation pattern in the first main scanning operation, the state of the nozzles of the inkjet head may be appropriately confirmed while causing the inkjet head to perform operations of drawing images to the image region. Further, by further causing the inkjet head to perform the second main scanning operation that makes the amount of ink discharged to regions other than the image region different from the first main scanning operation, during drawing of images to the image region, the inkjet head may be further caused to discharge ink for purposes other than confirmation of nozzle states to regions other than the image region. Thus, with such a configuration, the state of the nozzles may be confirmed efficiently and appropriately. Moreover, this enables more appropriate printing on the media.

In this configuration, in the second main scanning operation, it is conceivable to discharge ink to regions other than the image region, for example, to more reliably prevent drying of the nozzles. In this case, regarding the amount of ink discharged to regions other than the image region on the media, it is conceivable to make the amount of ink discharged in the second main scanning operation greater than the amount of ink discharged in the first main scanning operation. Moreover, regarding this point, depending on the characteristics of the ink used, merely causing the inkjet head to draw the nozzle state confirmation pattern may result in insufficient discharge amount of ink to regions other than the image region, making drying of the nozzles more likely to occur. In response to this, with such a configuration, by further performing the second main scanning operation in addition to the first main scanning operation, and in the second main scanning operation, instead of the operation of drawing the nozzle state confirmation pattern in the first main scanning operation, discharging a greater amount of ink from the inkjet head, drying of the nozzles may be made less likely to occur.

Moreover, in this configuration, the printing device performs printing using a multi-pass method in which the number of main scanning operations that may discharge ink to one position becomes multiple times. In this case, during execution of the first main scanning operation, the main scanning drive portion may cause the inkjet head to draw, as the nozzle state confirmation pattern, for example, a pattern in which ink dots formed by ink discharged in different main scanning operations do not overlap at the same position on the media, and each nozzle that drew each portion of the nozzle state confirmation pattern may be identified. With such a configuration, the state of the nozzles of the inkjet head may be appropriately confirmed based on the nozzle state confirmation pattern. Moreover, in this case, during execution of the second main scanning operation, the main scanning drive portion causes the inkjet head to discharge ink to at least some of regions other than the image region such that, for example, ink dots formed by ink discharged in different main scanning operations overlap at the same position on the media, thereby making it conceivable to make the amount of ink discharged to regions other than the image region different from the first main scanning operation. With such a configuration, the amount of ink discharged to regions other than the image region may be appropriately made different between the first main scanning operation and the second main scanning operation. Moreover, in this case, in the second main scanning operation, by discharging ink such that ink dots formed by ink discharged in different main scanning operations overlap at the same position on the media, a greater amount of ink may be discharged from the inkjet head onto the media. Furthermore, this may more appropriately prevent drying of the nozzles.

Moreover, in this configuration, the control portion sets a partial range of the media that is outside the image region in the main scanning direction as a pattern drawing region, which is a range for drawing the nozzle state confirmation pattern in the first main scanning operation. In this case, during execution of the first main scanning operation, the main scanning drive portion causes the inkjet head to draw the nozzle state confirmation pattern in the pattern drawing region. Moreover, in this case, during execution of the second main scanning operation, the main scanning drive portion causes a greater amount of ink to be discharged to the pattern drawing region than during execution of the first main scanning operation. With such a configuration, the amount of ink discharged to regions other than the image region may be appropriately made different between the first main scanning operation and the second main scanning operation. Moreover, in this case, in the second main scanning operation, by making the amount of ink discharged to the pattern drawing region greater than during execution of the first main scanning operation, a greater amount of ink may be discharged from the inkjet head onto the media. Furthermore, this may more appropriately prevent drying of the nozzles.

Moreover, in this configuration, depending on the characteristics of the ink used, it may be desirable to discharge ink to prevent nozzle drying each time a main scanning operation is performed. In such cases, in all main scanning operations performed to draw images that become products in the image region, the main scanning drive portion may cause the inkjet head to discharge ink to regions other than the image region. However, it is conceivable that the amount of ink discharged may be insufficient with only the ink discharge performed to draw the nozzle state confirmation pattern in the first main scanning operation. In such cases, at least during execution of the first main scanning operation, the main scanning drive portion may cause the inkjet head to discharge ink to positions other than the position where the nozzle state confirmation pattern is drawn, among regions outside the image region. With such a configuration, in the first main scanning operation, a greater amount of ink may be discharged from the inkjet head to regions other than the image region. Furthermore, this may more appropriately prevent drying of the nozzles.

Further, in this configuration, it is also conceivable to discharge ink to regions outside the image region toward the outside of the media. In this case, in at least some main scanning operations, it is conceivable to cause the inkjet head to discharge ink outside the media in addition to discharging ink to regions outside the image region on the media. For example, it is conceivable that at least during execution of the first main scanning operation, the main scanning drive portion causes the inkjet head to discharge ink also toward the outside of the media. With such a configuration, more ink may be discharged to regions other than the image region. Furthermore, this may more appropriately prevent drying of the nozzles.

Moreover, it is also conceivable to perform ink discharge outside the media in both the first main scanning operation and the second main scanning operation. It is also conceivable to perform ink discharge outside the media only in the first main scanning operation without performing it in the second main scanning operation. In this case, regarding the scan width, which is the range in which the inkjet head is moved during main scanning operation, the scan width in the second main scanning operation may be made narrower than the scan width in the first main scanning operation. By narrowing the scan width in some main scanning operations, the time required for main scanning operations may be shortened and printing speed may be increased. In this case, during execution of the first main scanning operation, the main scanning drive portion causes the inkjet head to discharge ink also to outside the media by moving the inkjet head relatively to the media in a range wider than a width of the media in the main scanning direction, and during execution of the second main scanning operation, the main scanning drive portion moves the inkjet head relatively to the media within a range of a width of the media in the main scanning direction. With such a configuration, printing speed may be appropriately increased compared to cases where the scan width is widened in all main scanning operations.

Further, the configuration of the present invention may also be considered from a different perspective than the above. For example, the characteristics of the configuration of the present invention may be considered by focusing on the configuration for causing the inkjet head to discharge ink toward the outside of the media. As such a configuration, for example, a configuration is conceivable that uses a platen that supports the media at a position facing the inkjet head and arranges ink receiving portions on two sides (one side and the other side) of the platen in the main scanning direction. The ink receiving portion is an example of a configuration that receives ink discharged from the inkjet head outside the media. Moreover, the present invention is, for example, a printing device that performs printing on media by an inkjet method, the printing device including: a main scanning drive portion, causing the inkjet head to perform a main scanning operation of discharging ink while moving relatively to the media in a preset main scanning direction; a platen, supporting the media at a position facing the inkjet head; and an ink receiving portion, receiving ink discharged from the inkjet head outside the media. The ink receiving portion is arranged on one side and other side of the platen at positions adjacent to the platen in the main scanning direction, and in at least some of the main scanning operations, the main scanning drive portion moves the inkjet head so as to pass through a position facing the platen after passing through a position facing the ink receiving portion and causes the inkjet head to discharge ink such that ink is discharged to the media on the platen after discharging ink to the ink receiving portion.

In the case of this configuration, the inkjet head may appropriately discharge ink outside the media. Further, this allows the inkjet head to appropriately discharge ink to regions other than the image region to more reliably prevent nozzle drying and the like. Thus, with this configuration, printing on the media may be performed more appropriately. Further, in this configuration, the inkjet head performs flushing at the position of the ink receiving portion. The ink receiving portion is a flushing box or the like that receives ink discharged by the inkjet head during flushing operation. Further, in this configuration, the main scanning drive portion, for example, causes the inkjet head to perform multiple main scanning operations. Then, in all main scanning operations that cause the inkjet head to discharge ink for drawing images that become printing products, the main scanning drive portion causes the inkjet head to discharge ink to the ink receiving portion. With this configuration, nozzle drying and the like may be prevented more reliably. Further, in this configuration, the main scanning drive portion causes the inkjet head to perform reciprocating main scanning operations that move the inkjet head in one side and the other side in the main scanning direction. Then, in this case, in each main scanning operation, the main scanning drive portion causes the inkjet head to discharge ink to at least the ink receiving portion that is on the upstream side relative to the platen in the direction of inkjet head movement. With this configuration, the inkjet head may appropriately discharge ink immediately before discharging ink to the image region. Further, this allows the inkjet head to more appropriately discharge ink to the image region.

Further, the printing device may further include a maintenance portion that performs maintenance on the inkjet head. The maintenance portion is configured to perform maintenance on the inkjet head at a position different from the ink receiving portion. At the maintenance portion, maintenance such as suction and wiping is performed on the inkjet head. At the maintenance portion, it is also conceivable to cause the inkjet head to perform flushing as at least part of the maintenance. Further, the maintenance portion is arranged at a position that sandwiches the ink receiving portion between the maintenance portion and the platen on one side of the platen in the main scanning direction. With this configuration, various maintenance on the inkjet head may be appropriately performed as needed.

Further, in this configuration, the ink receiving portion is preferably arranged with an upper surface height aligned with the platen. With this configuration, the discharge of ink to the ink receiving portion may be appropriately performed by the inkjet head under conditions close to those during ink discharge to the media. Further, this may appropriately prevent unintended airflow from occurring between the ink receiving portion and the inkjet head and prevent ink misting and the like from occurring. Further, in this configuration, the printing device may further include a configuration for collecting ink discharged to multiple ink receiving portions in one location. In this case, the printing device further includes a waste ink flow path that flows waste ink, which is ink discharged to the ink receiving portion, out of the ink receiving portion, and a waste ink storage portion that stores waste ink supplied from multiple ink receiving portions via the waste ink flow path. With this configuration, waste ink processing may be performed more easily and appropriately.

Further, as a configuration of the present invention, it is also conceivable to use a printing method or the like having the same features as described above. In this case as well, the same effects as described above may be obtained.

### Effects of Invention

According to the present invention, printing on media may be performed more appropriately.

### BRIEF DESCRIPTION OF DRAWINGS

FIGS. 1A, 1B, and 1C are diagrams that describe a printing device 10 according to one embodiment of the present invention. FIG. 1A shows an example of main parts of the printing device 10. FIG. 1B is a diagram showing a portion of the configuration shown in FIG. 1A from a different direction than FIG. 1A. FIG. 1C shows an example of the configuration of a head portion 12 in the printing device 10.

FIG. 2 is a diagram that describes throw-away performed by an inkjet head 102.

FIGS. 3A and 3B are diagrams that describe how to set a throw-away region. FIG. 3A shows an example of the positional relationship of a conveyor belt 14, media 50, and an image region 52. FIG. 3B shows an example of how to set a throw-away region.

FIG. 4A to 4C are diagrams that describe how to set a throw-away region. FIG. 4A to 4C show other examples of how to set a throw-away region.

FIG. 5 is a diagram showing an example of a printing operation performed in the printing device 10.

FIG. 6 is a diagram showing a modification example of the printing operation of the printing device 10.

FIGS. 7A and 7B are diagrams that describe in more detail features related to a flushing box 16. FIG. 7A shows an example of a configuration for collecting ink discharged to multiple flushing boxes 16 in one location. FIG. 7B shows an example of a specific configuration of the flushing box 16.

FIG. 8A to 8C are diagrams that describe a modification example of the configuration of the printing device 10. FIG. 8A is a cross-sectional view showing an example of the configuration of the printing device 10 in this modification example. FIG. 8B is a top view showing a partial configuration of the printing device 10. FIG. 8C is a diagram that describes the position of the flushing box 16 in the printing device 10.

### DESCRIPTION OF EMBODIMENTS

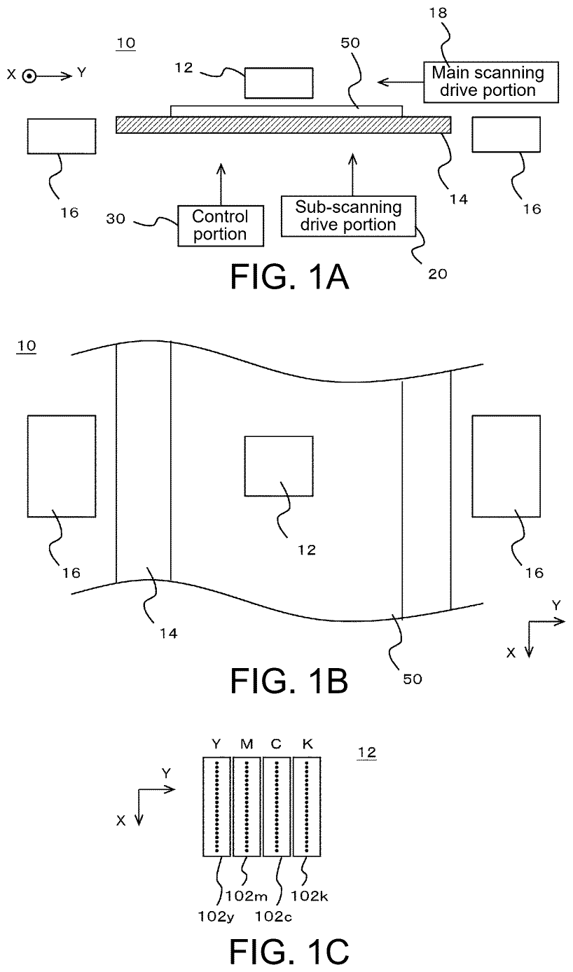

Hereinafter, embodiments according to the present invention will be described with reference to the drawings. FIGS. 1A, 1B, and 1C are diagrams that describe a printing device 10 according to one embodiment of the present invention. FIG. 1A shows an example of main parts of the printing device 10. FIG. 1B is a diagram showing a portion of the configuration shown in FIG. 1A from a different direction than FIG. 1A. FIG. 1C shows an example of the configuration of a head portion 12 in the printing device 10. The printing device 10 of this example is an inkjet printer that performs printing on a print target media 50 by an inkjet method, and includes a head portion 12, a conveyor belt 14, multiple flushing boxes 16, a main scanning drive portion 18, a sub-scanning drive portion 20, and a control portion 30.

The head portion 12 is a part that discharges ink to the media 50, and has multiple inkjet heads 102, for example, as shown distinguished as 102y, 102m, 102c, 102k in FIG. 1C. The inkjet head 102y discharges yellow (Y) color ink. The inkjet head 102m discharges magenta (M) color ink. The inkjet head 102c discharges cyan (C) color ink. The inkjet head 102k discharges black (K) color ink. Each color of YMCK in this example is an example of process color. Process color is an example of basic colors for color expression. Further, the inkjet head 102 has multiple nozzles that discharge ink, and discharges ink from the multiple nozzles. The head portion 12 may have inkjet heads 102 for colors other than those described above. Further, the multiple inkjet heads 102 that the head portion 12 of this example has are arranged in alignment at positions in a preset sub-scanning direction (X direction in the figure) in the printing device 10, and are arranged side by side in a main scanning direction (Y direction in the figure) orthogonal to the sub-scanning direction. In a modification example of the configuration of the head portion 12, the multiple inkjet heads 102 may be arranged in an arrangement different from FIG. 1C. Further, although illustration is omitted in FIG. 1B, the head portion 12 further has a carriage or the like that holds these inkjet heads 102.

The conveyor belt 14 is a belt that transports the media 50 in a transport direction parallel to the sub-scanning direction and supports the media 50 at a position facing the head portion 12 by placing the media 50 on the upper surface, while moving the media 50 in the transport direction at a predetermined timing. The media 50 is placed on the upper surface of the conveyor belt 14, for example, by being attached to the conveyor belt 14. The conveyor belt 14 is an example of a member that functions as a platen in the printing device 10. The platen is an example of a member that supports the media 50 at a position facing the head portion 12. The position facing the head portion 12 may be considered as a position facing the inkjet head 102 that the head portion 12 has.

The flushing box 16 is an example of an ink receiving portion that receives ink discharged from the inkjet head 102 outside the media 50, and receives ink discharged from nozzles of the inkjet head 102, for example, in the case of causing the inkjet head 102 to perform flushing. Flushing is an example of an operation that causes ink to be discharged from nozzles of the inkjet head 102 for maintenance of the inkjet head 102. By causing the inkjet head 102 to perform flushing periodically, drying of the nozzles may be appropriately prevented. Drying of the nozzles may be considered as ink drying in the vicinity of the nozzles, which affects the discharge characteristics of the nozzles. Further, flushing in this example is an example of throw-away performed by the inkjet head 102. Throw-away may be considered as an operation of discharging ink to a region other than the image region (print region), which is a region for drawing images that become printed products. As throw-away, for example, discharging ink by methods other than flushing may also be considered. Further, the printing device 10 of this example includes flushing boxes 16 on one side and the other side of the conveyor belt 14 in the main scanning direction. Accordingly, the inkjet head 102 performs flushing on one side and the other side of the conveyor belt 14 as necessary. Further, the inkjet head 102 of this example performs throw-away such as flushing at positions other than the flushing box 16. Throw-away such as flushing performed by the inkjet head 102 will be described in more detail later.

The main scanning drive portion 18 is a drive portion that causes the multiple inkjet heads 102 to perform main scanning operation (scan). The main scanning operation is an example of an operation that discharges ink while moving relatively in the main scanning direction with respect to the media 50. Further, the main scanning drive portion 18 of this example causes the multiple inkjet heads 102 to perform main scanning operation by, for example, moving the head portion 12 along a guide rail, which is a rail-shaped member not shown, while causing the multiple inkjet heads 102 to discharge ink. Further, the main scanning drive portion 18 causes the multiple inkjet heads 102 to discharge ink to discharge positions set according to images to be printed (user images) with respect to the image region of the media 50. Moreover, the main scanning drive portion 18 of this example further causes the multiple inkjet heads 102 to discharge ink for throw-away such as flushing to regions other than the image region as necessary.

The sub-scanning drive portion 20 is a drive portion that causes the multiple inkjet heads 102 to perform sub-scanning operation. The sub-scanning operation is an example of an operation that moves relatively in the sub-scanning direction with respect to the media 50. The sub-scanning drive portion 20 of this example causes the multiple inkjet heads 102 to perform sub-scanning operation by causing the conveyor belt 14 to transport the media 50. Further, the sub-scanning drive portion 20 changes the region where ink is discharged by the main scanning operation with respect to the media 50 by causing the multiple inkjet heads 102 to perform sub-scanning operation between main scanning operations. The main scanning drive portion 18 causes the multiple inkjet heads 102 to perform multiple main scanning operations according to the size of images to be printed in the image region. Further, the control portion 30 is a configuration that includes, for example, a CPU of the printing device 10, and controls the operation of each portion of the printing device 10. According to this example, printing operation with respect to the media 50 may be appropriately performed. Further, the multiple inkjet heads 102 may be appropriately caused to perform throw-away such as flushing as necessary.

It is noted that, except for the points described above and below, the printing device 10 and each configuration thereof may have the same or similar features as known printing devices and each configuration thereof. Further, as the media 50 of this example, for example, a fabric media 50 such as cloth is used. In this case, it is conceivable to use known ink for printing on the fabric media 50 (ink for textile printing) in the inkjet head 102. As the conveyor belt 14, for example, a configuration that is the same as or similar to a conveyor belt used in an inkjet printer for textiles may be suitably used. Further, the printing device 10 may further include a configuration that is the same as or similar to a known printing device, in addition to the illustrated configuration. For example, the printing device 10 may further include fixing means for fixing ink to the media 50. As the fixing means, for example, it is conceivable to use means for heating the media 50. Further, in the case of transporting the fabric media 50 by the conveyor belt 14, it is also conceivable that contamination occurs on the conveyor belt 14 due to ink that has passed through the media 50. Thus, it is preferable that the printing device 10 further include a cleaning mechanism for cleaning the conveyor belt 14.

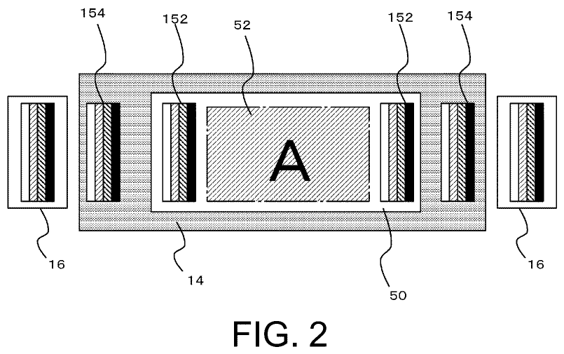

Next, the throw-away such as flushing performed by the inkjet head included in the head portion 12 of the printing device 10 will be described in more detail. FIG. 2 is a diagram for describing the throw-away performed by the inkjet head, and shows an example of positions where the inkjet head performs throw-away in this example. For convenience of illustration, in FIG. 2, the conveyor belt 14 and the image region 52 of the media 50 are provided with hatched patterns. Further, the flushing box 16 and the throw-away regions 152 and 154 described below are illustrated in a simplified manner as examples of states in which throw-away of multiple colors of ink is performed by the multiple inkjet heads. In the drawings described later, the same or similar illustrations as above are appropriately performed.

As described above, the inkjet head performs flushing, which is an example of throw-away, to the flushing box 16. Further, the inkjet head of this example performs throw-away such as flushing to throw-away regions 152 and 154 set at positions other than the flushing box 16 as necessary. The control portion 30 (see FIGS. 1A, 1B, and 1C) of the printing device 10 of this example sets an image region 52 in a partial range in the main scanning direction for the media 50 supported by the conveyor belt 14. The inkjet head discharges ink into the image region 52 during main scanning operation, thereby drawing an image that becomes a printed product in the image region 52. Further, the control portion 30 of this example further sets throw-away regions 152 and 154, for example, outside the image region 52, as shown in the figure. Then, the main scanning drive portion 18 (see FIGS. 1A, 1B, and 1C) causes the inkjet head to discharge ink to the throw-away regions 152 and 154 in at least some of the main scanning operations according to control by the control portion 30. The throw-away regions 152 and 154 are examples of regions where the inkjet head discharges ink outside the image region 52. Further, in the illustrated example, the throw-away region 152 is a region set on the media 50. Then, the throw-away region 154 is a region set on the conveyor belt 14 outside the media 50. The throw-away regions 152 and 154 may be considered as regions set at any position other than the image region 52 within the range where the inkjet head may discharge ink during main scanning operation. Further, as the throw-away region 152 on the media 50 and the throw-away region 154 outside the media 50, for example, multiple regions may be set, as shown in the figure. For example, as in this example, it is conceivable to set throw-away regions 152 on two sides of the image region 52 on the media 50 in the main scanning direction, and set throw-away regions 154 on two sides of the media 50 on the conveyor belt 14.

In this example, the inkjet head may be caused to perform throw-away printing to multiple locations including the multiple flushing boxes 16 and the multiple throw-away regions 152 and 154. Further, thereby, during main scanning operation or the like, the inkjet head may be caused to perform throw-away printing to the media 50, the conveyor belt 14, or the flushing box 16 as necessary. Thus, according to this example, printing to the media 50 may be performed more appropriately. Further, by being able to perform throw-away printing to locations other than the flushing box 16, compared to cases where throw-away printing is performed only to the flushing box 16 or the like, the inkjet head may be caused to perform throw-away printing of a larger amount of ink as necessary. Further, according to printing conditions or the like, the inkjet head may be caused to perform throw-away printing such as flushing without using the flushing box 16. Furthermore, by causing the inkjet head to discharge ink to the throw-away regions 152 and 154 outside the image region 52, the inkjet head may be caused to perform throw-away printing while appropriately suppressing influence on the image drawn in the image region 52. Further, by being able to perform throw-away printing to various locations, even in cases where there is no margin to set the throw-away region 152 on the media 50, the throw-away region 154 on the conveyor belt 14 and the flushing box 16 may be used to cause the inkjet head to appropriately perform throw-away printing without reducing or moving the image region 52 set on the media 50.

Further, the main scanning drive portion 18 of this example causes the inkjet head to perform throw-away printing including purposes other than flushing in at least some main scanning operations. More specifically, in at least some main scanning operations, the main scanning drive portion 18 causes the inkjet head to discharge ink for drawing a nozzle state confirmation pattern, rather than simple flushing, as throw-away printing to the throw-away region 152 on the media 50. The throw-away region 152 set on the media 50 may be considered as an example of a pattern drawing region that is a range for drawing the nozzle state confirmation pattern. Further, the nozzle state confirmation pattern is an example of a pattern for confirming the state of at least some nozzles in the inkjet head. As the nozzle state confirmation pattern, it is conceivable to use a pattern in which ink dots formed by ink discharged in different main scanning operations do not overlap at the same position on the media 50, and the nozzles that drew each part of the nozzle state confirmation pattern may be identified. By using such a nozzle state confirmation pattern, the state of the nozzles of the inkjet head may be appropriately confirmed. Further, as such a nozzle state confirmation pattern, a known pattern used for confirming the state of nozzles may be suitably used. As the nozzle state confirmation pattern, for example, a known ladder-like pattern drawn using all nozzles of the inkjet head may be suitably used.

Further, as described above, the printing device 10 of this example uses multiple inkjet heads to discharge ink for multiple colors. In this case, it is conceivable to cause all color inkjet heads to perform throw-away printing to the throw-away regions 152 and 154 and the flushing box 16. Depending on the characteristics of the ink used, printing conditions, and the like, some color inkjet heads may be used as inkjet heads that perform throw-away printing to one location. Further, the location where throw-away printing is performed, the color of ink for throw-away printing, and the like may be selected for each main scanning operation. Further, in the illustrated configuration, one side and the other side in the main scanning direction correspond to the right side and left side in the figure. The throw-away region 152 on the media 50 is an example of a location where throw-away printing is performed on the right side, left side, or both left and right sides of an image printed in the image region 52. The throw-away region 152 may also be considered as a throw-away printing location at the image edge on the media 50. The throw-away region 154 on the conveyor belt 14 is an example of a location where throw-away printing is performed near the right end, near the left end, or both of the conveyor belt 14. The throw-away region 154 may also be considered as a throw-away printing location at the belt edge. Further, the flushing box 16 is an example of a location where throw-away printing is performed on the right side, left side, or both left and right sides of the conveyor belt 14.

Further, in this example, by performing throw-away printing to the throw-away regions 152 and 154, a sufficient amount of ink may be discharged from the inkjet head, for example, even in the case of performing printing without using the flushing box 16. In this case, the range of movement of the inkjet head during main scanning operation may be set to a range narrower than the distance between the left and right flushing boxes 16. Further, this enables appropriate compatibility between maintaining the state of the nozzles of the inkjet head appropriately through throw-away printing and shortening the time required for each main scanning operation to increase printing speed (printing throughput). Further, by performing throw-away printing within a narrow range, it becomes possible to suppress consumption of ink and media. Thus, the configuration of this example is preferable because it enables saving of components, for example, from the perspective of SDGs.

Further, as described above, the inkjet head of this example performs, as throw-away printing, ink discharge for flushing and ink discharge for drawing a nozzle state confirmation pattern. The ink discharge for flushing is an example of discharge for maintaining the state of nozzles. Further, the ink discharge for flushing may be considered as a refresh operation for the inkjet head. The ink discharge for drawing a nozzle state confirmation pattern is an example of ink discharge for confirming the state of nozzles. Further, in the case of performing ink discharge for drawing a nozzle state confirmation pattern, by discharging ink from nozzles, it is possible to obtain an effect similar to flushing according to the amount of ink to be discharged. That is, the ink discharge for drawing a nozzle state confirmation pattern may also be used as an alternative to flushing (refresh).

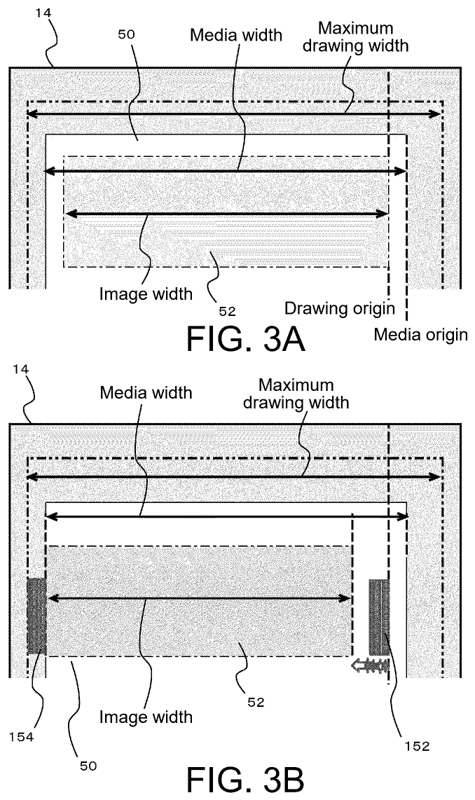

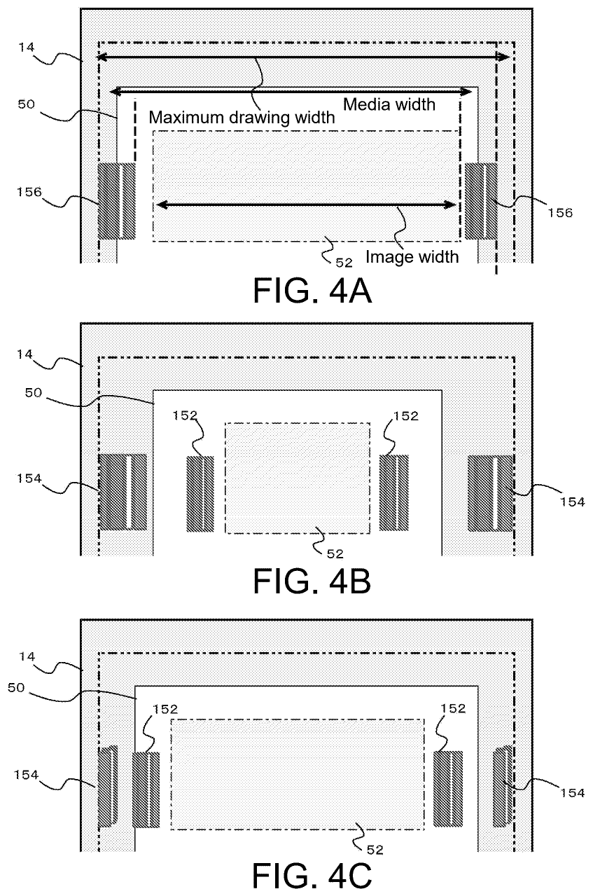

Next, the method of setting throw-away regions on the media 50 or on the conveyor belt 14 will be described in more detail. FIGS. 3A and 3B and FIG. 4A to 4C are diagrams for describing the method of setting throw-away regions. FIG. 3A shows an example of the positional relationship of a conveyor belt 14, media 50, and an image region 52. FIG. 3B shows an example of how to set a throw-away region. FIG. 4A to 4C show other examples of how to set a throw-away region. As described above, the media 50 of this example is placed on the upper surface of the conveyor belt 14. Further, the media 50 is placed within a predetermined drawing range on the conveyor belt 14. The drawing range is an example of a range in which the inkjet head discharges ink during main scanning operation. The media 50 of this example is placed on the conveyor belt 14 within the drawing range shown as the maximum drawing width in the figure in the main scanning direction. The width of the media 50 in the main scanning direction, shown as media width in the figure, becomes equal to or less than the maximum drawing width which is the width of the drawing range. Further, as described above, the image region 52 of this example is a partial range of the media 50 in the main scanning direction. Thus, the width of the image region 52 in the main scanning direction, shown as image width in the figure, becomes equal to or less than the width of the media 50.

In this case, it is conceivable to control the printing operation of the printing device 10 (see FIGS. 1A, 1B, and 1C) by setting the position of one end side of the media 50 in the main scanning direction as the media origin which is the origin position of the media 50, and setting a predetermined position on the media 50 in the main scanning direction as the drawing origin which is the origin position of the drawing operation. In the case of the configuration shown in FIG. 3A, the position of the right end of the media 50 in the figure is set as the media origin. Further, as shown in FIG. 3A, in the case of not setting the throw-away region 152 on the media 50, it is conceivable to set the position of the right end of the image region 52 in the figure as the drawing origin. In this case, the direction from right to left in the figure becomes the positive direction of coordinates corresponding to the media origin and the drawing origin. Further, in this example, the range that may be taken as the image width is determined according to the maximum drawing width, media width, media origin, and drawing origin. For example, in the case of setting the maximum drawing width to 1900 mm and making the media origin and drawing origin coincide with the end (right end) of the maximum drawing width, the image width becomes a maximum of 1900 mm according to the media width. Further, in the case of setting the distance between the end of the maximum drawing width and the media origin to 100 mm and setting the distance between the media origin and the drawing origin to 50 mm, the image width becomes a maximum of 1900−100−50=1750 mm according to the media width.

Further, the throw-away region 152 on the media 50 and the throw-away region 154 on the conveyor belt 14 are set in the main scanning direction to a range other than the image region 52 on the media 50 or to a portion on the conveyor belt 14 where the media 50 is not placed. As shown in FIG. 3B, the throw-away region 152 may be set only on one side of the image region 52 in the main scanning direction on the media 50, according to the amount of ink to be discharged by throw-away printing and the width of the range in which the throw-away regions 152 and 154 may be set. Further, similarly, the throw-away region 154 may be set only on one side of the media 50 in the main scanning direction on the conveyor belt 14. For example, as shown in the figure, it is conceivable to set the throw-away region 152 on one side of the media 50 in the main scanning direction with respect to the image region 52, and to set the throw-away region 154 on the conveyor belt 14 on the other side. With this configuration, even in the case of reducing the locations of the throw-away regions 152 and 154 to be set, throw-away printing may be performed on two sides of the image region 52 in the main scanning direction. Further, as shown in FIG. 3B, in the case of setting the throw-away region 152 on the right side of the image region 52 on the media 50, the position of the right end of the image region 52 becomes a position separated to the left side from the drawing origin. Then, the throw-away region 152 is set between the drawing origin and the position of the right end of the image region 52. Such a throw-away region 152 may also be considered to be set so as to expand from the drawing origin toward the positive direction of coordinates. Further, the throw-away region 154 on the conveyor belt 14 in this example is set within the range of the maximum drawing width in the main scanning direction and at a position that does not overlap with the media 50.

Up to this point, the description has mainly focused on examples of setting the throw-away region 152 on the media 50 and then setting the throw-away region 154 on the conveyor belt 14 separately from the throw-away region 152. In contrast, in another example of how to set the throw-away region, as shown in FIG. 4A for example, it is also conceivable to set a throw-away region 156 where a portion is on the media 50 and another part is on the conveyor belt 14 outside the media 50. As in the example shown in FIG. 4A, in the case of performing throw-away printing outside the media 50 on the right side of the media 50, it is conceivable to set the drawing origin outside the media 50. For example, it is conceivable to set the position of the right end of the throw-away region 156 in the main scanning direction as the drawing origin. In this case, for convenience of control, it is also conceivable to set the media origin at the same position as the drawing origin set outside the media 50.

Furthermore, the throw-away region 152 on the media 50 and the throw-away region 154 on the conveyor belt 14 may also be set on two sides of the image region 52 in the main scanning direction, as shown in FIG. 4B. Further, the method of throw-away printing to the throw-away region 152 or the throw-away region 154 may be made different between one side and the other side of the image region 52. As described above, the inkjet head of this example performs throw-away printing by discharging ink outside the image region 52 during main scanning operation. At this time, the amount of ink discharged in throw-away printing may be changed according to the width of the throw-away regions 152 and 154 in the main scanning direction. Further, the amount of ink discharged in throw-away printing may also be made different for each ink color (for each inkjet head). For example, the width in the main scanning direction of parts drawn with the same color ink in the throw-away regions 152 and 154 may be set for each color. Alternatively, for each location where throw-away printing is performed, the discharge amount of ink for each color and the discharge amount of ink for the total of all colors may be independently and individually set. It is also possible to select the color of ink discharged in throw-away printing, etc. Thus, according to this example, the amount of ink for throw-away printing in each main scanning operation may be flexibly set.

The range in which the throw-away region 152 may be set on the media 50 and the range in which the throw-away region 154 may be set on the conveyor belt 14 are determined according to the width of the media 50 and the position and width of the image region 52. That is, the width of the throw-away regions 152 and 154 in the main scanning direction is set according to the width of the media 50 and the position and width of the image region 52. In the case of the width of the range in which the throw-away region 152 or the throw-away region 154 may be set is small, it is conceivable to reduce the width of the throw-away region in the main scanning direction, such as the throw-away region 154 shown in FIG. 4C, by appropriately overlapping parts drawn with the same color ink with parts drawn with other color inks. With this configuration, throw-away printing may be appropriately performed even in the case of the width of the range in which throw-away printing is possible on the media 50 or the conveyor belt 14 is narrow. On the other hand, in the case of the width of the range in which the throw-away regions 152 and 154 may be set is sufficiently large, it is preferable to set the throw-away regions 152 and 154 so that parts drawn with different color inks do not overlap with each other. With this configuration, throw-away printing may be performed more appropriately while suppressing the amount of ink discharged per unit area.

As described above, according to this example, the throw-away region 152 on the media 50, the throw-away region 154 on the conveyor belt 14, and the like may be appropriately set. Further, this enables the inkjet head to appropriately perform throw-away printing during main scanning operation. Further, as described above, it is possible to flexibly and appropriately select the location where throw-away printing is performed, the color of ink discharged in throw-away printing, and the discharge amount for each main scanning operation. Further, according to need, the inkjet head may be made to perform throw-away printing to a narrow range in the main scanning direction. Further, as described above, in this example, the inkjet head may be made to perform throw-away printing to multiple locations including the throw-away region 152 on the media 50, the throw-away region 154 on the conveyor belt 14, and the flushing box 16 (see FIGS. 1A, 1B, and 1C). The location at which the throw-away printing should be performed may be determined by specifying the corresponding reference position (for example, the distance (interval) from the end of the image region 52, the end of the conveyor belt 14, the position of the flushing box 16, etc.). Further, regarding the position where the throw-away region 152 on the media 50 is set, for example, it may be moved following the movement of the origin of the image such as the drawing origin.

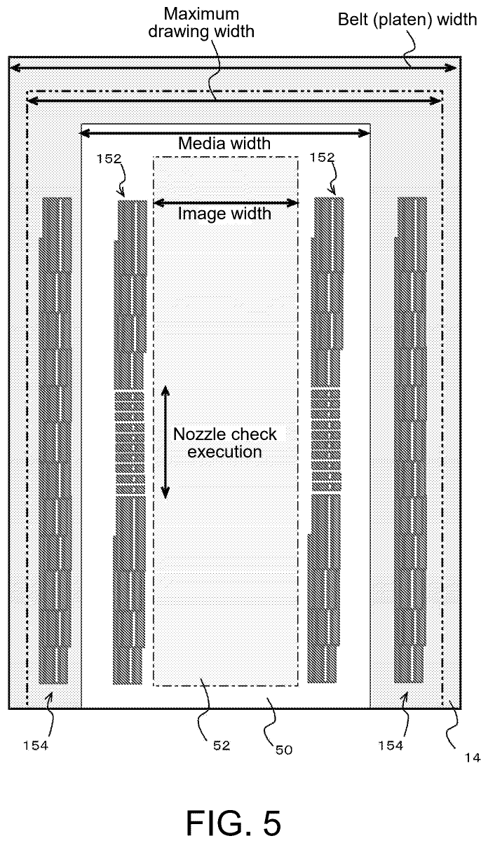

Further, as described above, as throw-away printing, for example, it is conceivable to make the inkjet head perform ink discharge for performing flushing. Further, the main scanning drive portion 18 (see FIGS. 1A, 1B, and 1C) of this example makes the inkjet head perform throw-away printing including purposes other than flushing in at least some main scanning operations. For example, as shown as nozzle check execution in FIG. 5, in some main scanning operations, the main scanning drive portion 18 makes the inkjet head perform ink discharge for drawing a nozzle state confirmation pattern to the throw-away region 152 on the media 50.

FIG. 5 is a diagram showing an example of a printing operation performed in the printing device 10 (see FIGS. 1A, 1B, and 1C), and shows an example of an operation for making the inkjet head draw a nozzle state confirmation pattern in some main scanning operations. As shown in the figure, the main scanning drive portion 18 of this example makes the inkjet head discharge ink to the throw-away regions 152 and 154, which are regions other than the image region 52, in the main scanning operation. The main scanning drive portion 18 of this example makes the method of ink discharge by the inkjet head to the throw-away region 152 on the media 50 differ between the main scanning operation performed in the range shown as nozzle check execution in the figure and the main scanning operations performed in other ranges. In the following, for convenience of description, the main scanning operation that makes the inkjet head draw a nozzle state confirmation pattern is referred to as nozzle check scanning. Further, main scanning operations other than nozzle check scanning are referred to as normal scanning. The nozzle check scanning is an example of a main scanning operation that makes the inkjet head draw a nozzle state confirmation pattern at least to regions other than the image region 52. The normal scanning is an example of a main scanning operation that makes the amount of ink discharged to regions other than the image region 52 differ from the nozzle check scanning. Further, the nozzle check scanning of this example is an example of a first main scanning operation. The normal scanning is an example of a second main scanning operation.

Further, in the printing device 10, whether to perform nozzle check scanning or normal scanning as the main scanning operation may be switched according to the setting of a nozzle check mode, which is an operation mode for confirming the state of nozzles (nozzle check). The control portion 30 (see FIGS. 1A, 1B, and 1C) of the printing device 10 switches whether to perform nozzle check scanning or normal scanning as the main scanning operation during the printing operation by turning on the nozzle check mode at some timings during the printing operation and turning off the nozzle check mode at other timings. Further, the portions shown as nozzle check execution in the figure are examples of periods in which the nozzle check mode is turned on. Moreover, the other portions are examples of periods in which the nozzle check mode is turned off. With this configuration, by switching the nozzle check mode on and off, the inkjet head may be made to draw the nozzle state confirmation pattern only in some of the main scanning operations. Further, by making the inkjet head draw the nozzle state confirmation pattern in the nozzle check scanning, the state of nozzles in the inkjet head may be appropriately confirmed while making the inkjet head perform the operation of drawing an image in the image region 52. Further, by making the amount of ink discharged to regions other than the image region 52 in normal scanning different from that in nozzle check scanning, the inkjet head may be made to appropriately perform flushing to regions other than the image region 52 during drawing of an image in the image region 52. The flushing performed by the inkjet head in the normal scanning of this example is an example of ink discharge for purposes other than confirmation of the state of nozzles. The flushing performed by the inkjet head in normal scanning may also be considered as ink discharge for more reliably preventing drying of nozzles, etc.

Further, the throw-away region 152 on the media 50 in this example is an example of a pattern drawing region. The pattern drawing region is an example of a range for drawing a nozzle state confirmation pattern in nozzle check scanning. The control portion 30 of the printing device 10 in this example sets a partial range of the media 50 that is outside the image region 52 in the main scanning direction as the throw-away region 152. Then, during execution of nozzle check scanning, the main scanning drive portion 18 causes the inkjet head to draw a nozzle state confirmation pattern on the throw-away region 152. Further, focusing on the amount of ink discharged to the throw-away region 152, during execution of normal scanning, the main scanning drive portion 18 causes a larger amount of ink to be discharged to the throw-away region 152 than during execution of nozzle check scanning. The amount of ink discharged to the throw-away region 152 during execution of nozzle check scanning or normal scanning is the amount of ink that the inkjet head discharges to the throw-away region 152 in one main scanning operation. Further, the amount of ink discharged in normal scanning in this example is larger than the amount of ink in nozzle check scanning. With this configuration, the amount of ink discharged to regions other than the image region 52 may be appropriately differentiated between nozzle check scanning and normal scanning.

Further, by making the amount of ink discharged to the throw-away region 152 in normal scanning larger than during execution of nozzle check scanning, a larger amount of ink may be discharged from the inkjet head onto the media 50. This may more appropriately prevent nozzle drying and the like. Here, discharging ink to the throw-away region 152 in nozzle check scanning may also be considered as an operation that also serves as flushing. However, depending on the characteristics of the ink used and the like, merely causing the inkjet head to draw a nozzle state confirmation pattern may result in insufficient discharge amount of ink to regions other than the image region 52, making nozzle drying and the like more likely to occur. In contrast, in this example, as described above, normal scanning operation is further performed in addition to nozzle check scanning. Next, regarding ink discharge to the throw-away region 152 on the media 50, the main scanning drive portion 18, instead of the operation of drawing a nozzle state confirmation pattern in nozzle check scanning, causes a larger amount of ink to be discharged from the inkjet head in normal scanning. Thus, according to this example, even in the case of causing the inkjet head to draw a nozzle state confirmation pattern, nozzle drying and the like may be made less likely to occur.

Further, depending on the characteristics of the ink used and the like, in order to prevent nozzle drying, it may be desirable to perform throw-away of a predetermined amount or more of ink each time a main scanning operation is performed. And in such cases, it is conceivable to cause the inkjet head to perform throw-away to regions other than the image region 52 in all main scanning operations performed to draw images that become products in the image region 52. However, ink discharge performed only to draw a nozzle state confirmation pattern may result in insufficient amount of discharged ink in some cases. In such cases, the main scanning drive portion 18 causes the inkjet head to discharge ink to positions other than the throw-away region 152, which is the position where the nozzle state confirmation pattern is drawn, among regions outside the image region 52, at least during execution of nozzle check scanning. With this configuration, in nozzle check scanning, a larger amount of ink may be discharged from the inkjet head to regions other than the image region 52. Further, this may appropriately prevent nozzle drying due to insufficient amount of ink discharged in throw-away. In the case of the operation shown in FIG. 5, the main scanning drive portion 18 causes the inkjet head to perform throw-away to the throw-away region 154 on the conveyor belt 14 in addition to the throw-away region 152 on the media 50. The throw-away region 154 is an example of a position other than the throw-away region 152 among regions outside the image region 52. In other words, it may also be considered that the main scanning drive portion 18 causes the inkjet head to discharge ink to the outside of the media 50 at least during execution of nozzle check scanning.

Further, in the case of the operation shown in the figure, the main scanning drive portion 18 causes the inkjet head to discharge ink to the throw-away region 154 outside the media 50 in normal scanning as well. Ink discharge to the outside of the media 50 is performed in both nozzle check scanning and normal scanning. With this configuration, in each main scanning operation, a necessary amount of ink throw-away may be performed more easily and appropriately to regions outside the image region 52. Further, in a modification example of the printing operation of the printing device 10, in at least some main scanning operations, the main scanning drive portion 18 may further cause the inkjet head to perform throw-away to the flushing box 16 (see FIGS. 1A, 1B, and 1C). At this time, the main scanning drive portion 18 may cause the inkjet head not to perform throw-away to the flushing box 16 during execution of normal scanning, and to perform throw-away to the flushing box 16 only during execution of nozzle check scanning. Even during execution of nozzle check scanning in which the discharge amount of ink to the throw-away region 152 on the media 50 becomes small, by further causing the inkjet head to perform throw-away to the flushing box 16, the total amount of ink discharged from the inkjet head in throw-away may be appropriately increased. Further, by not performing throw-away to the flushing box 16 in normal scanning, it becomes possible to prevent excessive reduction in printing speed.

Further, the printing device 10 of this example performs printing on the media 50 using a multi-pass method. The multi-pass method is an example of a method in which the number of main scanning operations capable of discharging ink to one position becomes multiple times. The multi-pass method may also be considered as a method of performing multiple main scanning operations for each position in a region where printing is performed on the media 50. Further, in the case of defining the width in the sub-scanning direction of a range in which one inkjet head may discharge ink in one main scanning operation as the print width of the inkjet head, the multi-pass method may also be considered as a method of making the feed amount, which is the distance that the inkjet head moves relatively to the media 50 in one sub-scanning operation, smaller than the print width. The print width may also be considered as the width in the sub-scanning direction of a range in which nozzles are arranged in the inkjet head. Further, the number obtained by dividing the print width by the feed amount is the number of passes in the multi-pass method. Further, the inkjet head has a nozzle array in which multiple nozzles are arranged with their positions shifted from each other in the sub-scanning direction. The value obtained by dividing the nozzle array length, which is the width of the nozzle array in the sub-scanning direction, by the feed amount of the sub-scanning operation may also be considered as the number of passes. Next, FIG. 5 shows an example in the case of setting the number of passes to 2 (in the case of 2 passes).

As described above, the nozzle state confirmation pattern in this example uses a pattern in which dots formed by ink discharged in different main scanning operations do not overlap at the same position on the media, and the nozzles that drew each part of the nozzle state confirmation pattern may be identified. Next, in the case of performing printing using the multi-pass method as in this example, it is conceivable to make the method of drawing the nozzle state confirmation pattern a method adapted to the operation of the multi-pass method. In the case of performing printing using the multi-pass method, the number of main scanning operations capable of discharging ink to each discharge position set according to the printing resolution becomes multiple times determined according to the number of passes. Further, in the case of performing throw-away for the purpose of flushing, it is desired to discharge a sufficient amount of ink to the throw-away region 152 and the like in each main scanning operation. Thus, for example, it is conceivable to discharge ink in an overlapping manner through multiple main scanning operations to the same discharge position (one discharge position) in the throw-away region 152 and the like. Such an operation is an example of an operation of performing overlapping discharge for the number of passes to one discharge position.

However, in the case of dots formed by ink discharged in different main scanning operations overlapping at the same position on the media 50, even if a predetermined pattern is drawn in the throw-away region 152 and the like, it usually becomes difficult to identify the nozzles that drew that pattern. Thus, in the case of causing the inkjet head to draw a nozzle state confirmation pattern in the throw-away region 152, it is preferable to cause the inkjet head to discharge ink by a method different from the ink discharge method simply for the purpose of flushing. The main scanning drive portion 18 of this example causes the inkjet head to draw each portion of the nozzle state confirmation pattern by ink discharge in any one main scanning operation. Causing the inkjet head to draw each part of the nozzle state confirmation pattern means causing any one of the multiple inkjet heads for multiple colors to discharge ink to the discharge positions of ink constituting each portion of the nozzle state confirmation pattern. Further, such an operation may be considered as an operation of discharging ink only in any one main scanning operation (pass) without performing overlapping discharge for the number of passes to one discharge position. Further, by causing the inkjet head to perform nozzle check scanning in this manner, it is possible to cause the inkjet head to appropriately draw known ladder-shaped patterns and the like.

Further, during execution of normal scanning, the main scanning drive portion 18 causes the inkjet head to discharge ink such that dots formed by ink discharged in different main scanning operations overlap at the same position on the media 50 with respect to the throw-away region 152 on the media 50. With this configuration, it is possible to appropriately differentiate the amount of ink discharged to regions other than the image region 52 in normal scanning from that during execution of nozzle check scanning. Further, in normal scanning, it is possible to cause the inkjet head to discharge a larger amount of ink to the throw-away region 152 on the media 50 compared to during execution of nozzle check scanning. This may more appropriately prevent nozzle drying and the like. According to this example, it is possible to appropriately confirm the state of the nozzles of the inkjet head based on the nozzle state confirmation pattern while appropriately performing flushing as a whole printing operation.

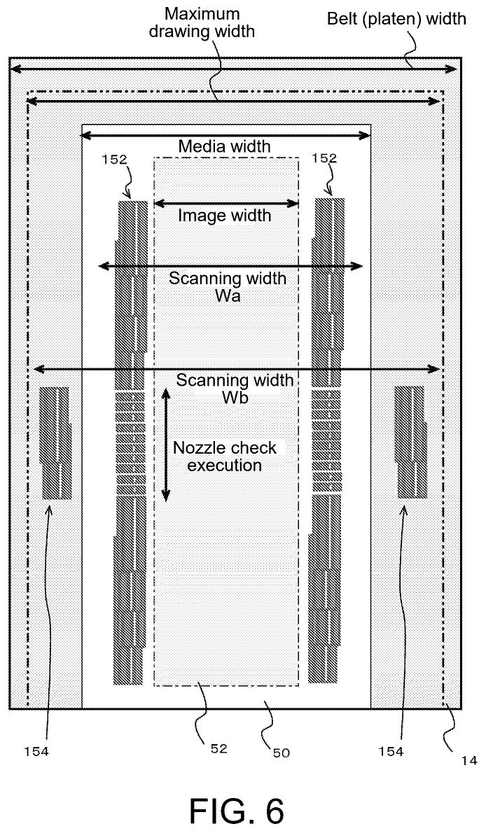

Here, as described above, in the operation shown in FIG. 5, in both normal scanning and nozzle check scanning, the inkjet head is caused to perform throw-away printing to the throw-away region 154 set outside the media 50. In contrast, in a modification example of the printing operation of the printing device 10, for example, as shown in FIG. 6, it is also conceivable to perform ink discharge outside the media 50 only in nozzle check scanning without performing the same in normal scanning. FIG. 6 shows a modification example of the operation of the printing device 10. Except for the points described below, in FIG. 6, configurations assigned the same reference numerals as in FIG. 5 may have the same or similar features as in FIG. 5.

As described above, in the case of performing nozzle check scanning, the amount of ink discharged to the throw-away region 152 on the media 50 becomes less than the ink discharge amount in normal scanning. Then, depending on the characteristics of the ink, etc., for example, merely causing the inkjet head to draw a nozzle state confirmation pattern on the throw-away region 152 may result in insufficient ink discharge amount to regions other than the image region 52, making nozzle drying and the like more likely to occur. Thus, in nozzle check scanning, it is preferable to cause the inkjet head to perform throw-away printing not only to the throw-away region 152 on the media 50, but also to the throw-away region 154 set outside the media 50 or the flushing box 16 (see FIGS. 1A, 1B, and 1C), etc. Further, it is conceivable that the throw-away printing to the throw-away region 154 and the like is performed with a larger amount of ink than the throw-away printing performed to draw the nozzle state confirmation pattern, causing the inkjet head to discharge ink. In contrast, in the case of normal scanning, depending on the ink characteristics and the width of the range that may be set as the throw-away region 152, and the like, nozzle drying may be appropriately prevented only by throw-away printing to the throw-away region 152 on the media 50, without performing throw-away printing to the throw-away region 154 and the like outside the media 50. In this case, it is also conceivable to cause the inkjet head to perform a main scanning operation that does not discharge ink outside the media 50 as normal scanning. In this case, it is conceivable to make the scan width in normal scanning narrower than the scan width in nozzle check scanning. The scan width is the range (range in the main scanning direction) in which the inkjet head is moved during main scanning operation.

The scan width in normal scanning is set on the media 50, for example, like the scan width Wa shown in the figure. In response to execution of normal scanning, the main scanning drive portion 18 (see FIGS. 1A, 1B, and 1C) moves the inkjet head relatively to the media 50 within the range of the width of the media 50 in the main scanning direction. The scan width Wa in normal scanning may be set according to the positions of the image region 52 and the throw-away region 152 set on the media 50. In contrast, the scan width in nozzle check scanning is set to a range that may discharge ink at least to the throw-away region 154 set outside the media 50, like the scan width Wb shown in the figure. In response to execution of nozzle check scanning, the main scanning drive portion 18 moves the inkjet head relatively to the media 50 in a range wider than the width of the media 50 in the main scanning direction, thereby causing the inkjet head to discharge ink also to the outside of the media 50. Further, in the case of also performing ink discharge to the flushing box 16 in nozzle check scanning, the scan width Wb in nozzle check scanning is set to a range that may discharge ink also to the flushing box 16. In this example, by narrowing the scan width of normal scanning, the time required for one main scanning operation is shortened. In this way, by narrowing the scan width in some main scanning operations corresponding to normal scanning, compared to the case of making the scan width of all main scanning operations the same wide width as nozzle check scanning, the printing speed may be increased as a whole. Furthermore, by not performing throw-away printing to the throw-away region 154 on the conveyor belt 14 in normal scanning, the total amount of ink discharged onto the conveyor belt 14 may be reduced. Further, this may also make it difficult to cause contamination of the cleaning liquid (cleaning water, etc.) used in response to cleaning the conveyor belt 14.

Next, supplementary description regarding each configuration described above will be provided. For convenience of description, the following may refer to the configuration of this example, including the modification examples described above and below. As described above, the main scanning drive portion 18 of this example causes the inkjet head to perform throw-away printing for the purpose of flushing to the throw-away region 152 on the media 50 and the throw-away region 154 on the conveyor belt 14 in at least some of the main scanning operations. The control portion 30 (see FIGS. 1A, 1B, and 1C) of the printing device 10 determines the amount of ink to be discharged in the throw-away printing for the purpose of flushing. Further, the control portion 30 determines the amount of ink to be discharged by the inkjet head to the throw-away regions 152 and 154, etc., based on ink characteristics, printing conditions, and the like. As printing conditions, for example, printing resolution, number of passes, and the like are considered. The amount of ink to be discharged by the inkjet head to the throw-away regions 152 and 154, etc., is adjusted, for example, by changing the width of the throw-away regions 152 and 154 in the main scanning direction. Further, as described above, the amount of ink to be discharged by the inkjet head to the throw-away regions 152 and 154, etc., for example, may be made different for each ink color. With this configuration, the amount of ink discharged in the throw-away printing to the throw-away regions 152 and 154, etc., may be appropriately set to an amount that may maintain the state of the nozzles of the inkjet head. Further, the control portion 30 may determine the amount of each color ink to be discharged by the inkjet head to the throw-away regions 152 and 154, etc., based on the amount of each color ink discharged to the image region 52 on the media 50 in each main scanning operation.

Further, as described above, the inkjet head of this example may perform throw-away printing to multiple locations including the throw-away region 152 on the media 50, the throw-away region 154 on the conveyor belt 14, and the flushing box 16. The conditions for throw-away printing performed at each location may be set individually for each main scanning operation and for each location. With this configuration, various conditions for throw-away printing may be flexibly set. Further, it is conceivable to determine the conditions for throw-away printing at each location according to the configuration of the printing device 10, printing conditions, and the like. For example, it is conceivable to determine the positions where the throw-away regions 152 and 154 are set, the amount of ink discharged to each location, and the like, based on at least part of the width of the conveyor belt 14, the width of the media 50, the distance (interval) from reference positions such as the media origin or drawing origin, printing density, the size of ink dots formed on the media 50, the overlapping method of ink dots, and the frequency of performing throw-away printing. Further, it is conceivable to consider the overlapping method of ink dots for each nozzle row, each ink color, or all ink dots. Further, as the frequency of performing throw-away printing, it is conceivable to consider how many main scanning operations are performed before throw-away printing is performed.

Further, in the printing operation described using FIG. 5 and FIG. 6, normal scanning and nozzle check scanning are performed as main scanning operations. That is, throw-away printing is performed in two types of operation modes. The nozzle check scanning is an example of a main scanning operation executed in an operation mode that draws a nozzle state confirmation pattern. The normal scanning is an example of a main scanning operation executed in an operation mode that performs flushing to prevent nozzle drying without drawing a nozzle state confirmation pattern. Further, as described above, during execution of nozzle check scanning, the main scanning drive portion 18 causes the inkjet head to draw each portion of the nozzle state confirmation pattern in only one main scanning operation. Thus, for example, in the case of performing 2-pass printing as in the printing operation described using FIG. 5 and FIG. 6, the main scanning drive portion 18 causes the inkjet head to discharge ink in one of the two main scanning operations capable of discharging ink to that position, for each portion of the nozzle state confirmation pattern. Further, printing on the media 50 may be performed with a number of passes other than 2 passes. The main scanning drive portion 18 causes the inkjet head to discharge ink in one of the main scanning operations for the number of passes capable of discharging ink to that position, for each part of the nozzle state confirmation pattern. For example, in the case of performing 4-pass printing, the main scanning drive portion 18 causes the inkjet head to draw each part of the nozzle state confirmation pattern by one of the four main scanning operations executed for the same position.

Further, as described above, in the case of the operation shown in FIG. 5, by making the method of performing throw-away printing to the throw-away region 152 on the media 50 different between normal scanning and nozzle check scanning, the amount of ink discharged to regions other than the image region 52 is made different between normal scanning and nozzle check scanning. In this case, regarding the total amount of ink discharged in throw-away printing in one main scanning operation, the discharge amount of ink in throw-away printing during normal scanning becomes greater than the discharge amount of ink in throw-away printing during nozzle check scanning. In contrast, in the case of the operation shown in FIG. 6, by not performing throw-away printing outside the media 50 during normal scanning, the discharge amount of ink by throw-away printing during normal scanning in one main scanning operation becomes less than the discharge amount of ink by throw-away printing during nozzle check scanning. In this case as well, by making the method of performing throw-away printing to the throw-away region 152 on the media 50 different between normal scanning and nozzle check scanning, it may be considered that the amount of ink discharged to regions other than the image region 52 is made different between normal scanning and nozzle check scanning.

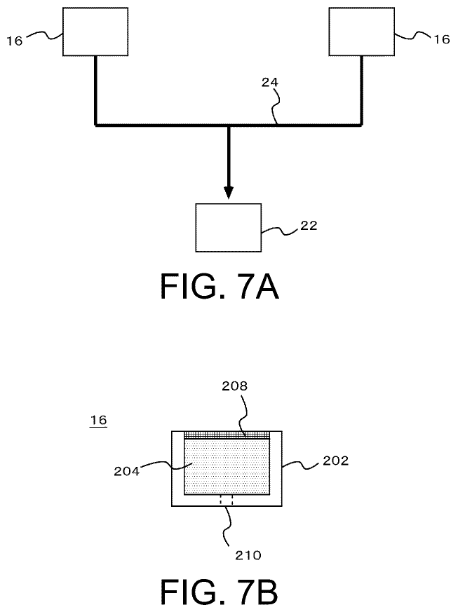

Further, as described above, the printing device 10 of this example includes multiple flushing boxes 16. The printing device 10 preferably further includes a configuration for collecting ink discharged to the multiple flushing boxes 16 in one location, for example as shown in FIG. 7A. FIGS. 7A and 7B are diagrams that describe features related to the flushing box 16 in more detail. FIG. 7A shows an example of a configuration for collecting ink discharged to multiple flushing boxes 16 in one location. In the illustrated configuration, the printing device 10 further includes a waste ink storage portion 22 and a pipe 24. The waste ink storage portion 22 is configured to store waste ink supplied from the multiple flushing boxes 16 via the pipe 24. The waste ink storage portion 22 is arranged below the flushing box 16 in the vertical direction. The pipe 24 is a flow path that flows waste ink, which is ink discharged to the flushing box 16, from the flushing box 16 to the waste ink storage portion 22. The pipe 24 of this example is an example of a waste ink flow path that flows waste ink out of the flushing box 16. By configuring in this way, waste ink from multiple flushing boxes 16 may be collected in one location. In this case, the process of disposing waste ink need only be performed for the one waste ink storage portion 22, without having to be performed individually for the multiple flushing boxes 16. Thus, by configuring in this way, waste ink processing may be performed more easily. Further, this may improve the maintainability of the printing device 10.

As the flushing box 16, for example, the configuration shown in FIG. 7B may be considered for use. FIG. 7B shows an example of a specific configuration of the flushing box 16. The flushing box 16 of the illustrated configuration has a housing portion 202, a sponge 204, and a mesh portion 208. The housing portion 202 is a portion that serves as the housing of the flushing box 16. The housing portion 202 of this example is a box-shaped body with an open upper surface and accommodates the sponge 204 inside. Further, a discharge hole 210 connected to the pipe 24 is formed on the lower surface of the housing portion 202. The sponge 204 is an absorber that absorbs waste ink. The mesh portion 208 is a member in which holes for passing waste ink are formed in a mesh pattern and presses the sponge 204 from the upper surface side of the housing portion 202. As the mesh portion 208, for example, a metal mesh member (metal mesh) or the like may be suitably used. By using the flushing box 16 having such a configuration, ink discharged by the inkjet head may be appropriately received.

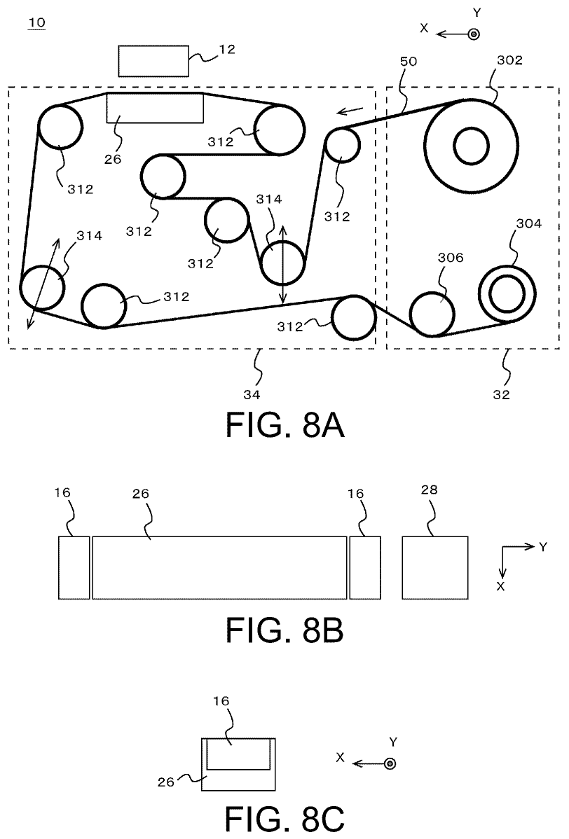

Up to this point, the configuration of the printing device 10 that transports the media 50 mainly using the conveyor belt 14 (see FIGS. 1A, 1B, and 1C) has been described. The conveyor belt 14 is an example of a member that functions as a platen that supports the media 50 at a position facing the inkjet head. In contrast, in a modification example of the configuration of the printing device 10, it is also conceivable not to use the conveyor belt 14. For example, it is conceivable to use the printing device 10 having the configuration shown in FIG. 8A to 8C. FIG. 8A to 8C are diagrams for describing a modification example of the configuration of the printing device 10. FIG. 8A is a cross-sectional view showing an example of the configuration of the printing device 10 in this modification example. FIG. 8B is a top view showing a partial configuration of the printing device 10, and shows an example of a partial configuration of the printing device 10 including configurations not illustrated in FIG. 8A. FIG. 8C is a diagram that describes the position of the flushing box 16 in the printing device 10. Except for the points described below, in FIG. 8A to 8C, configurations assigned the same reference numerals as in FIG. 1A to FIG. 7B may have the same or similar features as the configurations shown in FIG. 1A to FIG. 7B. For example, the printing device 10 and each portion of the printing device 10 may have the same or similar features as the printing device 10 and each portion of the printing device 10 described using FIG. 1A to FIG. 7B, other than the points described below. Further, the printing device 10 and each portion of the printing device 10 described using FIG. 1A to FIG. 7B may have the same or similar features as the printing device 10 and each portion of the printing device 10 described below, other than the points described above.

The printing device 10 of the present modification example includes a platen 26, sequentially feeds out media 50 wound in a roll shape to perform printing, and further winds up the media 50 after printing. As a configuration related to transport of the media 50, the printing device 10 includes a feeding portion 302, a winding portion 304, multiple rollers 306 and 312, and multiple tension bars 314. In addition to the configuration illustrated in FIG. 8A, the printing device 10 further includes, for example, multiple flushing boxes 16, a main scanning drive portion 18 (see FIGS. 1A, 1B, and 1C), a sub-scanning drive portion 20 (see FIGS. 1A, 1B, and 1C), a control portion 30, a waste ink storage portion 22 (see FIGS. 7A and 7B), and pipes 24 (see FIGS. 7A and 7B), similar to the configurations shown in FIG. 1A to FIG. 7B. Further, for example, as shown in FIG. 8B, the printing device 10 of the present modification example includes a maintenance portion 28. Among the above configurations, the part having the feeding portion 302, the winding portion 304, and the roller 306 is an example of the media feeding and winding portion 32 in the printing device 10. Further, the portion other than the media feeding and winding portion 32 in the printing device 10 is an example of the main body portion 34 in the printing device 10. The media feeding and winding portion 32 is an example of a portion that performs supply and recovery of the media 50 to and from the main body portion 34 by feeding out and winding up the media 50. The main body portion 34 is an example of a portion that executes printing on the media 50 supplied from the media feeding and winding portion 32. Further, among the configurations in the media feeding and winding portion 32, the feeding portion 302 is a portion that performs feeding out of the media 50, holds the media 50 wound in a roll shape, and supplies the media 50 to the main body portion 34 by sequentially feeding out the media 50 according to the progress of printing. The winding portion 304 is a portion that performs winding up of the media 50 on which printing has been performed in the main body portion 34. The roller 306 is a roller that contacts the media 50 in the transport path in the media feeding and winding portion 32. As the roller 306, for example, it is conceivable to use a driven roller that rotates with the movement of the media 50.

Further, regarding the configuration in the main body portion 34, among the configuration shown in FIG. 8A, the platen 26 is a member that supports the media 50 at a position facing the inkjet head of the head portion 12. The platen 26 may also be considered as a member that supports the media 50 at a position that becomes the image region. The platen 26 supports the media 50 at a height position that becomes the printing surface. The multiple rollers 312 are rollers that contact the media 50 in the transport path of the main body portion 34, and contact the media 50 at each position of the transport path that guides the media 50 supplied from the media feeding and winding portion 32 onto the platen 26 and then returns it to the media feeding and winding portion 32. As the roller 312, for example, it is conceivable to use a driven roller. Further, as some of the rollers 312, for example, it is conceivable to use a roller driven by the sub-scanning drive portion 20. The multiple tension bars 314 are members that apply tension to the media 50 during transport. By using these configurations, the media 50 may be appropriately transported along the transport path that passes through the position facing the inkjet head. Further, the sub-scanning drive portion 20 moves the media 50 in the transport direction by driving the winding portion 304. Further, the sub-scanning drive portion 20 may drive, for example, the feeding portion 302 or some of the rollers 312 in the main body portion 34.

The flushing box 16 of this modification example is, for example, arranged on one side and the other side of the platen 26 so as to be adjacent to the platen 26 in the main scanning direction, as shown in FIG. 8B. The flushing box 16 of this modification example is arranged on two sides of the platen 26 in the main scanning direction. Further, the maintenance portion 28 is arranged on one side of the platen 26 in the main scanning direction. The maintenance portion 28 is a configuration that performs maintenance on the inkjet head. The maintenance portion 28 of this modification example is at a position sandwiching the flushing box 16 with the platen 26. Further, the maintenance portion 28 of this modification example is an example of a configuration that performs maintenance on the inkjet head at a position different from the flushing box 16. The maintenance portion 28 performs maintenance such as suction and wiping on the inkjet head. Further, in the maintenance portion 28, it is conceivable to cause the inkjet head to perform flushing as at least portion of the maintenance. That is, the maintenance portion 28 may also be considered as a configuration that receives ink discharged from the inkjet head outside the media 50, similar to the flushing box 16. However, as described above, in this modification example, the flushing boxes 16 arranged on two sides of the platen 26 have a different configuration from the maintenance portion 28. That is, the printing device 10 includes multiple flushing boxes 16 separately from the maintenance portion 28. By using the maintenance portion 28, various maintenance may be performed on the inkjet head as needed. Further, as in this modification example, in the case of arranging the flushing box 16 at a position adjacent to the platen 26 in the main scanning direction (beside the platen 26), it is preferable to bring the flushing box 16 as close as possible to the platen 26 in order to minimize the movement distance of the head portion 12 (movement distance of the carriage).

Further, the flushing box 16 of this modification example is arranged with the height of the upper surface aligned with the platen 26, as shown in FIG. 8C. Aligning the height of the upper surface of the flushing box 16 with the platen 26 may be considered as matching the height of the upper surface of the mesh portion 208 (see FIGS. 7A and 7B) in the flushing box 16 with the height of the upper surface of the platen 26. By unifying the heights of the flushing box 16 and the platen 26, ink may be discharged from the inkjet head to the flushing box 16 without moving either the inkjet head or the flushing box 16 in the height direction. Further, in this case, the discharge of ink to the flushing box 16 may be performed under conditions close to those during the discharge of ink to the media 50 on the platen 26. Furthermore, since the gap between the inkjet head becomes substantially the same on the media 50 and on the flushing box 16, it is possible to prevent unintended airflow from occurring between the flushing box 16 and the inkjet head, and prevent ink misting and the like from occurring. This enables printing with higher quality.

Further, the main scanning drive portion 18 causes the inkjet head to perform flushing by causing the inkjet head to discharge ink at the position of the flushing box 16. The main scanning drive portion 18 moves the inkjet head so that in at least some of the main scanning operations, the inkjet head passes through a position facing the flushing box 16 and then passes through a position facing the platen 26, and drives the inkjet head to discharge ink to the flushing box 16 and then discharge ink to the media 50 on the platen 26. With this configuration, the inkjet head may appropriately discharge ink outside the media 50. Further, this enables the inkjet head to appropriately perform flushing to regions other than the image region. In this modification example as well, the main scanning drive portion 18 causes the inkjet head to perform multiple main scanning operations. In all main scanning operations that cause the inkjet head to discharge ink for drawing images that become printed products, the main scanning drive portion 18 causes the inkjet head to discharge ink to the flushing box 16. With this configuration, nozzle drying and the like may be prevented more reliably. Further, the main scanning drive portion 18 causes the inkjet head to perform reciprocating main scanning operations that move the inkjet head in one direction and the other direction in the main scanning direction. In each main scanning operation, the main scanning drive portion 18 causes the inkjet head to discharge ink to at least the flushing box 16 that is on the upstream side relative to the platen 26 in the direction of movement of the inkjet head. With this configuration, the inkjet head may appropriately discharge ink immediately before discharging ink to the image region. This enables the inkjet head to appropriately discharge ink to the image region. In this modification example, it may also be considered that such operation is made possible by arranging the flushing boxes 16 on two sides of the platen 26. In each main scanning operation, the main scanning drive portion 18 may cause the inkjet head to discharge ink to the flushing boxes 16 on two sides of the platen 26.

In the above, in relation to the operation of the printing device 10 described using FIG. 1A to FIG. 7B, the operation of performing throw-away such as flushing onto the media 50 is described. In contrast, in a modification example of the operation of the printing device 10, throw-away such as flushing does not necessarily have to be performed on the media 50. In this case as well, by causing the inkjet head to discharge ink to the flushing box 16, nozzle drying and the like may be appropriately prevented. Further, the effect of throw-away may be obtained without using the printable range on the media 50. Further, in this case as well, by arranging the flushing boxes 16 on two sides of the platen 26 in the main scanning direction, the inkjet head may be caused to appropriately perform throw-away in each main scanning operation.

Further, the configuration of arranging the flushing boxes 16 on two sides of the platen 26 in the main scanning direction is particularly preferably used in combination with a configuration where nozzle drying is likely to occur. For example, in the case of using ink that easily dries, such as sublimation transfer type ink, as the ink of the printing device 10, it is preferable to arrange the flushing boxes 16 on two sides of the platen 26 in the main scanning direction and cause the inkjet head to discharge ink to the flushing boxes 16 in all main scanning operations. Further, in the case of using media 50 having a wide width in the main scanning direction, it is considered that nozzle drying is likely to occur due to the longer time required for one main scanning operation. Particularly, in the case of the media 50 having a width of 1800 mm or more, it is considered that nozzle drying is likely to occur. Thus, in such cases as well, it is preferable to arrange the flushing boxes 16 on two sides of the platen 26 in the main scanning direction and cause the inkjet head to discharge ink to the flushing boxes 16 in all main scanning operations.

### INDUSTRIAL APPLICABILITY

The present invention may be suitably utilized in, for example, printing devices.

1. A printing device that performs printing on media using an inkjet method, the printing device comprising:
an inkjet head, having a plurality of nozzles that discharge ink;
a main scanning drive portion, causing the inkjet head to perform a main scanning operation of discharging ink while moving relatively to the media in a preset main scanning direction;
a sub-scanning drive portion, causing the inkjet head to perform a sub-scanning operation of moving relatively to the media in a sub-scanning direction orthogonal to the main scanning direction; and
a control portion, controlling operations of the inkjet head, the main scanning drive portion, and the sub-scanning drive portion,
wherein the main scanning drive portion causes the inkjet head to perform the main scanning operation a plurality of times,
the sub-scanning drive portion causes the inkjet head to perform the sub-scanning operation between the main scanning operations,
in response to a region for drawing an image that becomes a product of printing being defined as an image region, the control portion sets the image region in a partial range of the media in the main scanning direction,
in at least some of the main scanning operations, the main scanning drive portion causes the inkjet head to discharge ink to a region other than the image region on the media, and
as the main scanning operations that cause the inkjet head to discharge ink to a region other than the image region, at least:
a first main scanning operation that is the main scanning operation causing the inkjet head to draw a nozzle state confirmation pattern, which is a pattern for confirming a state of at least some of the nozzles in the inkjet head, on a region other than the image region; and
a second main scanning operation that is the main scanning operation making an amount of ink discharged to a region other than the image region different from the first main scanning operation are caused to be performed by the inkjet head.

2. The printing device according to claim 1, wherein printing is performed by a multi-pass method in which a number of the main scanning operations capable of discharging ink to one position becomes a plurality of times,
during execution of the first main scanning operation, the main scanning drive portion causes the inkjet head to draw, as the nozzle state confirmation pattern, a pattern in which ink dots formed by ink discharged in different main scanning operations do not overlap at the same position on the media and each nozzle that drew each portion of the nozzle state confirmation pattern may be identified, and
during execution of the second main scanning operation, the main scanning drive portion causes the inkjet head to discharge ink such that ink dots formed by ink discharged in different main scanning operations overlap at the same position on the media for at least a portion of a region other than the image region, thereby making an amount of ink discharged to a region other than the image region different from the first main scanning operation.

3. The printing device according to claim 1, wherein the control portion sets a partial range of the media that is outside the image region in the main scanning direction as a pattern drawing region that is a range for drawing the nozzle state confirmation pattern in the first main scanning operation, and
for the pattern drawing region,
during execution of the first main scanning operation, the main scanning drive portion causes the inkjet head to draw the nozzle state confirmation pattern, and
during execution of the second main scanning operation, the main scanning drive portion causes a larger amount of ink to be discharged than during execution of the first main scanning operation.

4. The printing device according to claim 1, wherein in all the main scanning operations performed to draw an image that becomes the product in the image region, the main scanning drive portion causes the inkjet head to discharge ink to a region other than the image region, and
at least during execution of the first main scanning operation, the main scanning drive portion causes the inkjet head to discharge ink also to positions other than a position where the nozzle state confirmation pattern is drawn, among regions outside the image region.

5. The printing device according to claim 1, wherein at least during execution of the first main scanning operation, the main scanning drive portion causes the inkjet head to discharge ink also to outside the media.

6. The printing device according to claim 5, wherein during execution of the first main scanning operation, the main scanning drive portion causes the inkjet head to discharge ink also to outside the media by moving the inkjet head relatively to the media in a range wider than a width of the media in the main scanning direction, and
during execution of the second main scanning operation, the main scanning drive portion moves the inkjet head relatively to the media within a range of a width of the media in the main scanning direction.

7. A printing method for performing printing on media using an inkjet method, the printing method comprising:
causing an inkjet head having a plurality of nozzles that discharge ink to perform a main scanning operation of discharging ink while moving relatively to the media in a preset main scanning direction and a sub-scanning operation of moving relatively to the media in a sub-scanning direction orthogonal to the main scanning direction;
causing the inkjet head to perform the main scanning operation a plurality of times while causing the inkjet head to perform the sub-scanning operation between the main scanning operations;
in response to a region for drawing an image that becomes a product of printing being defined as an image region, setting the image region in a partial range of the media in the main scanning direction;
in at least some of the main scanning operations, causing the inkjet head to discharge ink to a region other than the image region on the media; and
as the main scanning operations that cause the inkjet head to discharge ink to a region other than the image region, at least:
a first main scanning operation that is the main scanning operation causing the inkjet head to draw a nozzle state confirmation pattern, which is a pattern for confirming a state of at least some of the nozzles in the inkjet head, on a region other than the image region; and
a second main scanning operation that is the main scanning operation making an amount of ink discharged to a region other than the image region different from the first main scanning operation are caused to be performed by the inkjet head.

8. A printing device that performs printing on media using an inkjet method, the printing device comprising:
an inkjet head, having nozzles that discharge ink;
a main scanning drive portion, causing the inkjet head to perform a main scanning operation of discharging ink while moving relatively to the media in a preset main scanning direction;
a platen, supporting the media at a position facing the inkjet head; and
an ink receiving portion, receiving ink discharged from the inkjet head outside the media,
wherein the ink receiving portion is arranged on one side and other side of the platen at positions adjacent to the platen in the main scanning direction, and
in at least some of the main scanning operations, the main scanning drive portion moves the inkjet head so as to pass through a position facing the platen after passing through a position facing the ink receiving portion and causes the inkjet head to discharge ink such that ink is discharged to the media on the platen after discharging ink to the ink receiving portion.

9. The printing device according to claim 8, wherein the main scanning drive portion causes the inkjet head to perform the main scanning operation a plurality of times, and
in all the main scanning operations that cause the inkjet head to discharge ink for drawing an image that becomes a product of printing, the main scanning drive portion causes the inkjet head to discharge ink to the ink receiving portion.

10. The printing device according to claim 8, further comprising a maintenance portion that performs maintenance on the inkjet head,
wherein the maintenance portion is arranged at a position sandwiching the ink receiving portion between the maintenance portion and the platen on one side of the platen in the main scanning direction.

11. The printing device according to claim 8, wherein the ink receiving portion is arranged with an upper surface height aligned with the platen.

12. The printing device according to claim 8, further comprising:
a waste ink flow path, flowing waste ink, which is ink discharged to the ink receiving portion, out of the ink receiving portion; and
a waste ink storage portion, storing the waste ink supplied from a plurality of ink receiving portions via the waste ink flow path.

13. (canceled)

14. The printing method according to claim 7, wherein printing is performed by a multi-pass method in which a number of the main scanning operations capable of discharging ink to one position becomes a plurality of times,
during execution of the first main scanning operation, causing the inkjet head to draw, as the nozzle state confirmation pattern, a pattern in which ink dots formed by ink discharged in different main scanning operations do not overlap at the same position on the media and each nozzle that drew each portion of the nozzle state confirmation pattern may be identified, and
during execution of the second main scanning operation, causing the inkjet head to discharge ink such that ink dots formed by ink discharged in different main scanning operations overlap at the same position on the media for at least a portion of a region other than the image region, thereby making an amount of ink discharged to a region other than the image region different from the first main scanning operation.

15. The printing method according to claim 7, wherein setting a partial range of the media that is outside the image region in the main scanning direction as a pattern drawing region that is a range for drawing the nozzle state confirmation pattern in the first main scanning operation, and
for the pattern drawing region,
during execution of the first main scanning operation, causing the inkjet head to draw the nozzle state confirmation pattern, and
during execution of the second main scanning operation, causing a larger amount of ink to be discharged than during execution of the first main scanning operation.

16. The printing method according to claim 7, wherein in all the main scanning operations performed to draw an image that becomes the product in the image region, causing the inkjet head to discharge ink to a region other than the image region, and
at least during execution of the first main scanning operation, causing the inkjet head to discharge ink also to positions other than a position where the nozzle state confirmation pattern is drawn, among regions outside the image region.

17. The printing method according to claim 7, wherein at least during execution of the first main scanning operation, causing the inkjet head to discharge ink also to outside the media.

18. The printing method according to claim 17, wherein during execution of the first main scanning operation, causing the inkjet head to discharge ink also to outside the media by moving the inkjet head relatively to the media in a range wider than a width of the media in the main scanning direction, and
during execution of the second main scanning operation, moving the inkjet head relatively to the media within a range of a width of the media in the main scanning direction.

19. The printing method according to claim 7, wherein supporting the media by a platen at a position facing the inkjet head.

20. The printing method according to claim 19, wherein using an ink receiving portion arranged at positions adjacent to the platen on one side and other side of the platen in the main scanning direction to receive ink discharged from the inkjet head outside the media.

21. The printing method according to claim 20, wherein in at least some of the main scanning operations, moving the inkjet head so as to pass through a position facing the platen after passing through a position facing the ink receiving portion and causing the inkjet head to discharge ink such that ink is discharged to the media on the platen after discharging ink to the ink receiving portion.
